(19) United States
(12) Patent Application Publication
(10) Pub. No.: US 2005/0183585 A1
(43) Pub. Date: Aug. 25, 2005

(54) Cooking utensils for steaming food

(75) Inventor: Andres Emparanza Knorr, Vitoria (ES)

Correspondence Address: BROWDY AND NEIMARK, P.L.L.C.;624 NINTH STREET, NW, SUITE 300, WASHINGTON, DC, 20001-5303, US

(73) Assignee: I.E.G., S.A., Vitoria (Alava) (ES)

(21) Appl. No.: 10/989,250

(22) Filed: Nov. 17, 2004

(30) Foreign Application Priority Data
Feb. 19, 2004 (ES) 200400401.0

(51) Int. Cl. A47J 37/12

(52) U.S. Cl. 99/403

(57) ABSTRACT

The invention describes a set of cooking utensils for steaming food, essentially a casserole or main part and another casserole or secondary part which is inserted into the main part, with the novelty that the secondary part remains suspended on some notches provided on the inner walls or sides of the main part. With this system of engagement, the secondary part can have a smaller size than in traditional designs, thereby reducing the cost and the complexity of its manufacturing and simplifying its cleaning and storage.

### TECHNICAL SECTOR

The invention relates to recipients or casseroles used for steaming food, in particular to those recipients whose interior has two levels of food or ingredients, a lower level at which the steam is emitted and a higher level where the food is going to be cooked with this steam.

### STATE OF THE ART

In order to arrange the food at two levels, so that the food at the upper level are cooked with the steam created during the cooking of the food at the lower level, utensils are known on the market which are composed of several parts, generally including a casserole or main part and a casserole or second par, which is placed inside the main part and is responsible for providing the said upper level for food and therefore for holding the food which is cooked by steaming. This secondary part usually has holes or slots in it to enable the steam to pass through, and it is normally manufactured in materials such as stainless steel, plastic, ceramic, etc. As regards the shape of this secondary part and its positioning inside the main part, there are several alternatives on the market that offer different solutions.

One of these solutions is based on the fact that the secondary part has a casserole shape and is inserted into the main part so that the edges of both engage in such a way that the secondary part hangs inside the main part, without touching its bottom. In this alternative, the food which is steam-cooked is housed inside the secondary part.

Another known solution is based on a secondary part, again with the shape of a casserole, which is placed inside the main part, although in this case it rests on the bottom of the main part and is also inverted, so that the opening in it faces downward and its edges are in contact with the bottom of the main part. In this alternative, the food to be steam-cooked is placed on top of the inverted secondary part.

The above solutions have a common disadvantage in that, in order to ensure that the food to be steam-cooked remains positioned inside the main part, the secondary part has to be designed in the shape of a casserole. This requirement for a casserole shape arises from the fact that the engagement or contact area between the secondary part and the main part is not close to the food area itself of the secondary part, as this engagement or contact takes place either at the opening or on the bottom of the main part.

On the other hand, food held by the secondary part in order to be steam-cooked is normally non-liquid food that remains situated on the surface of the secondary part, and does not require for it to be correctly situated. As a result, the walls of the secondary part do not perform any other function than the previously mentioned one of providing a method of engagement between the parts.

With the aim of improving on the currently existing solutions, the main objective considered for the invention is to achieve a utensil that requires a smaller amount of material for its manufacture and is, therefore, more economical and simpler to manufacture.

To this effect, the invention seeks to achieve a secondary part which, while performing the functions required, is smaller in size than the secondary parts currently used, making it also simpler to use, clean, store, etc.

### DETAILED DESCRIPTION OF THE INVENTION

In order to achieve the objectives above, the invention defines some utensils used for steam-cooking food, fundamentally a main part and a secondary part, in which the secondary part is positioned inside the main part so as to form an upper level for food to be steam-cooked, and which is characterised mainly because the secondary part does not engage or make contact with the main part at the opening or at the bottom of the main part, but on its walls, at a certain distance between its opening and its bottom.

To achieve this, the walls of the main part are provided with notches or recesses projecting inwards, which act as supports for the secondary part. It is on these notches, therefore, where the edges of the secondary part are supported.

In different application alternatives of the invention, the main part can have a design in which the internal width in the area situated below the notches is smaller or equal to the internal width in the area situated above the notches.

The notches can be of any shape, with the main shape proposed by the invention being a series of approximately circular concavities and convexities.

The invention offers many alternatives with regard to the shape of the secondary part, while at the same time the notch in the main part can be situated at different heights. For example, the secondary part might be a tray which is not very deep, for which the notch in the main part can be situated at any height. In another example, the secondary part might alternatively be a deeper tray or a small casserole, engaging with a notch in the main part situated somewhat higher.

In either of these cases, the widest part of the secondary part is smaller than the width of the main part in the area of the notches, and it is also provided with some rim edges or protruding elements which are larger in width than the main part in the area of the notches. In this manner, when it is inserted into the main part, the secondary part avoids the notches and finally becomes suspended on the said notches when the protruding elements come into contract with the notches.

In another method of manufacturing the secondary part, it can be flat and larger in width than the width of the main part in the area of the notches, so that in its final positioning, the secondary part rests on the notches on the interior of the main part.

### DESCRIPTION OF THE FIGURES

The details of the invention can be appreciated by referring to the accompanying figures, which do not seek to place restriction on the invention but rather to be illustrative examples of it:

FIG. 1 represents a kind of steam-cooking utensils known in the state of the art.

FIG. 2 shows another kind of steam-cooking utensils known in the state of the art.

FIG. 3 shows a first method of producing the main part in accordance with the invention.

FIG. 4 shows a detail of FIG. 3.

FIG. 5 shows a second method of producing the main part in accordance with the invention.

FIG. 6 shows a detail of FIG. 5.

FIG. 7 shows an elevation and profile of a method of producing the secondary part in accordance with the invention.

FIG. 8 shows a detail of FIG. 7.

FIG. 9 shows the positioning of the secondary part shown in FIG. 7 inside the main part shown in FIG. 3.

FIG. 10 shows a detail of FIG. 9.

FIG. 11 shows the positioning of the secondary part shown in FIG. 7 inside the main part shown in FIG. 5.

FIG. 12 shows a detail of FIG. 11.

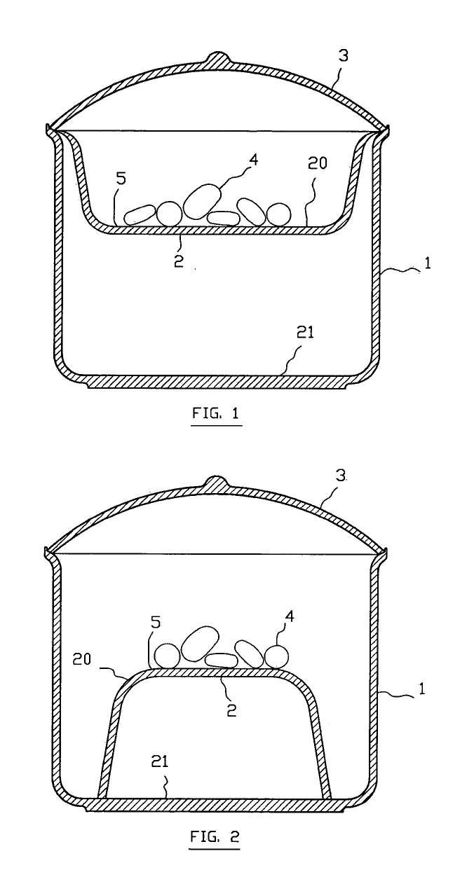

FIG. 1 represents one of the kinds of steam-cooking utensils known in the state of the art, which consists essentially of a main part (1), a secondary part (2) and an optional lid (3), and in which the secondary part (2) has the approximate shape of a deep casserole and is situated hanging or suspended from the main part itself (1). The food (4) which is going to be steam-cooked is held in the interior of the secondary part (2), on the support surface (5), so that in this way the food at the upper level (20) is cooked with the steam created by cooking other foods or liquids at the lower level (21).

FIG. 2 represents a second kind of steam-cooking utensils known in the state of the art, in which the secondary part (2) once again is similar to a deep casserole, but in this case it is placed in an inverted position and supported on the bottom or base of the main part (1). As with the previous figure, the food (4) is cooked at the upper level (20) with the steam created by cooking other foods or liquids situated at the lower level (21), but in this case the support surface (5) for the food (4) is on the outer side of the said secondary part (2).

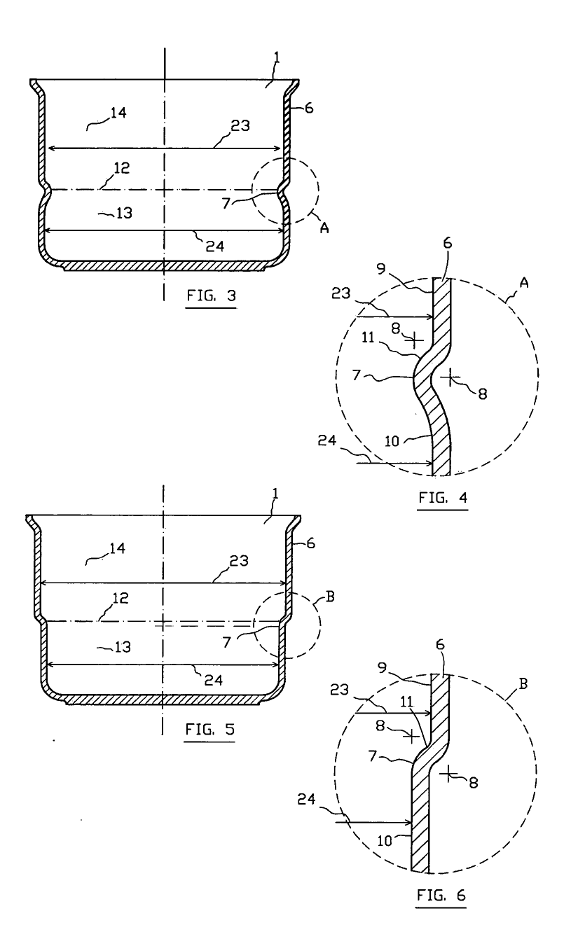

FIG. 3 represents a method of manufacturing the main part in accordance with the invention, in which the main part (1) has a protruding notch (7) or recess running around the circumference of its walls or sides (6) and projecting in towards the interior, on which the secondary part is supported, as can be observed in later figures. In the case shown in FIG. 3, the width (24) of the lower part (13) of the main part (1) is equal to the width (23) of the upper part (14), where the upper (14) and lower (13) parts are understood to be the parts delimited above and below, respectively, an imaginary line or plane (12) situated at the same height as the notch (7).

In FIG. 4, a detail of FIG. 3 can be appreciated, which more specifically corresponds to the area A around the notch (7). In this method of manufacturing, the profile of the notch, seen in cross-section, is similar to a series of two curved circular parts of circumferential centres (8). Moreover, the area (10) of wall (6) situated below the notch (7) is vertically aligned with the area (9) situated above the notch (7). On the upper part of the notch (7) shown in the figure, a support area (11) is defined, on which the secondary part can be positioned and supported, as can be observed in later figures.

A second method of manufacturing the main part in accordance with the invention is represented in FIG. 5, in which the main part (1) once again has a notch (7) or recess running around the circumference of its walls or sides (6) and projecting inwards towards the interior, on which the secondary part is supported, as can be observed in later figures. In the case of FIG. 5, the width (24) of the lower part (13) of the main part (1) is smaller than the width (23) of the upper part (14), where the upper (14) and lower (13) parts are understood to be the parts delimited above and below, respectively, an imaginary line or plane (12) situated at the same height as the notch (7).

A detail of FIG. 5 can be appreciated in FIG. 6, and more specifically corresponding to the area B around the notch (7). In this method of manufacturing, and just like the method of manufacturing illustrated in FIG. 4, the profile of the notch, seen in cross-section, is similar to a series of two curved circular parts of circumferential centres (8), so that a support area (11) becomes defined on the upper part of the notch (7), on which the secondary part can be positioned and supported, as can be observed in later figures. However, in this case and in relation to FIG. 4, the area (10) of the wall (6) situated below the notch (7) is not vertically aligned with the area (9) situated above the notch (7).

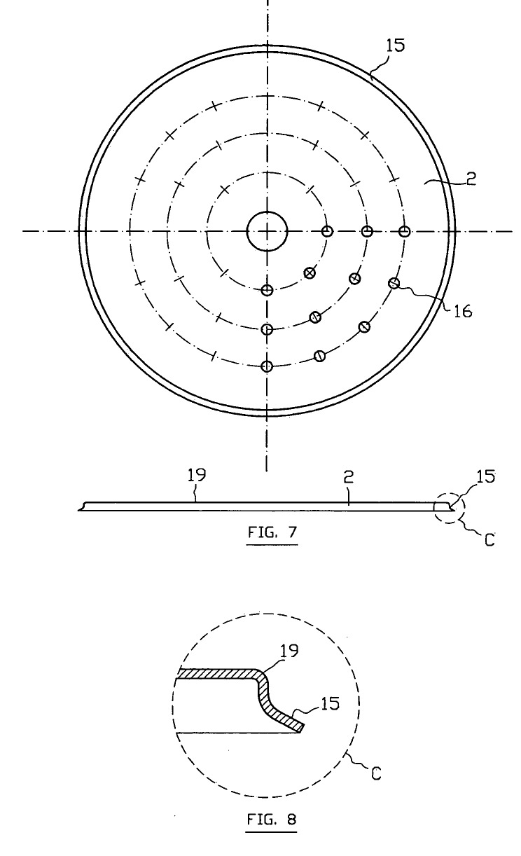

In FIG. 7, plan and profile views are represented of a possible method of manufacturing the secondary part, which in this case is similar to a relatively shallow circular tray. The secondary part (2) consists essentially of a main body (19), which in its final positioning is going to be suspended below the notches on the main part, and also a rim edge or protruding element (15) whose purpose is to provide the engagement or contact surface between the secondary part (2) and the main part, as can be observed in later figures.

In FIG. 8, an enlarged cross-section view of area C in FIG. 7 is shown, in which the shape of the rim edge or protruding element (15) can be seen in detail.

The use of the main part in the example in FIG. 3 with the secondary part in FIG. 7 gives rise to a final positioning of the whole assembly as shown in FIG. 9. In this figure, the final situation can be appreciated, in accordance with the invention, of the secondary part (2) in relation to the main part (1), with this situation being characterised in that the secondary part (2) makes contact with the main part (1) around its perimeter, with the rim edge or protruding element (15) being supported on the notch (7) on the main part (1). The secondary part (2) remains suspended, without touching the bottom of the main part (1). In this way, two levels for food are defined, a lower level (21) for boiling or cooking some initial foods or liquids, and an upper level (20) for the food which is going to be steam-cooked, and more specifically for the food (4) situated on top of the secondary part (2).

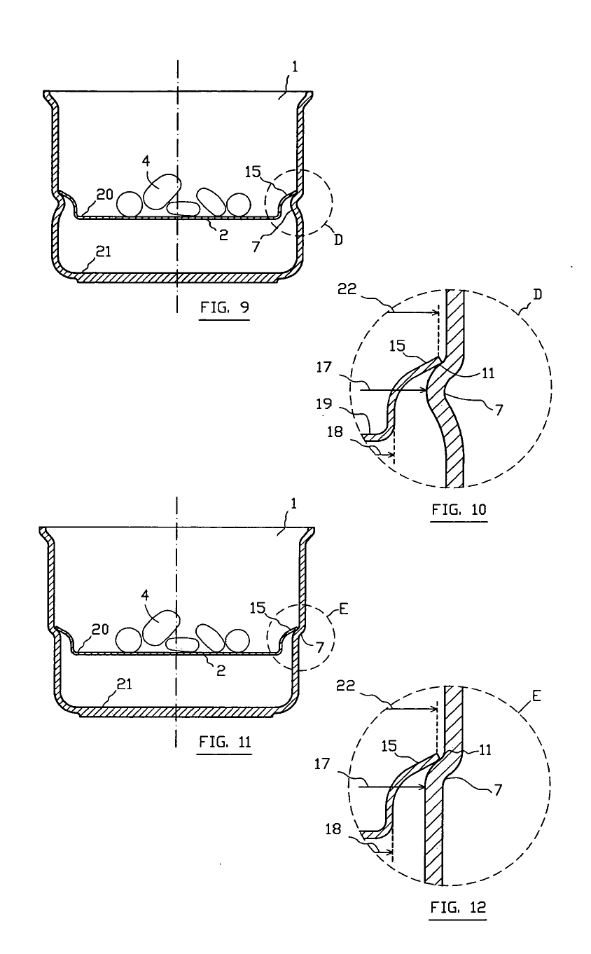

FIG. 10 shows an enlarged view of the contact area D between the secondary part (2) and the main part (1) in FIG. 9. In this enlarged view, it can be clearly appreciated how the rim edge or protruding element (15) makes contact with the support area (11) of the notch (7), enabling the secondary part to become seated or supported in the interior of the main part. In the same way, it can be observed that the width (18) of the body (19) of the secondary part is smaller than the width (17) of the main part in the area of the notches (7).

The use of the main part in the example in FIG. 5 with the secondary part in FIG. 7 gives rise to a final positioning of the whole assembly as shown in FIG. 11. In this figure, the final situation can be appreciated, in accordance with the invention, of the secondary part (2) in relation to the main part (1), with this situation being characterised, just like in FIG. 9, in that the secondary part (2) makes contact with the main part (1) around its perimeter, with its rim edge or protruding element (15) being supported on the notch (7) on the main part (1). The secondary part (2) remains suspended, without touching the bottom of the main part (1). In this way, two levels for food are defined, a lower level (21) for boiling or cooking some initial foods or liquids, and an upper level (20) for the food which is going to be steam-cooked, and more specifically for the food (4) situated on top of the secondary part (2).

FIG. 12 shows an enlarged view of the contact area E between the secondary part (2) and the main part (1) in FIG. 9. In this enlarged view, it can be clearly appreciated how the rim edge or protruding element (15) makes contact with the support area (11) of the notch (7), enabling the secondary part to become seated or supported in the interior of the main part. In the same way, it can be observed that the width (18) of the body (19) of the secondary part is smaller than the width (17) of the main part in the area of the notches (7).

In FIGS. 9 and 11, corresponding to the final positioning of the two methods of manufacturing the invention, the lid has not been represented, because it is not an essential part of the invention and, moreover, its use is optional.

1. Cooking utensils for steaming food, with these utensils being understood to mean a casserole or main part (1) and a secondary part (2), in which the secondary part (2) in its final positioning is situated in the interior of the main part (1) with the purpose of providing an upper level (20) where food (4) can be placed for steam-cooking, which are characterised in that:
the main part (1) is provided, around all or some of its walls or sides (6), with notches or recesses (7) which are sufficient to enable the secondary part (2) to be supported,
the secondary part (2) is provided with one or more rim edges or protruding elements (15), in such a way that the width (22) of the secondary part (2) in the area of the rim edges or protruding elements (15) is greater than the interior width (17) of the main part (1) in the area of the notches (7),
the final positioning of the secondary part (2) in relation to the main part (1) is such that the rim edges or protruding elements (15) of the secondary part (2) remain supported on the notches (7) on the main part (1).

2. Cooking utensils for steaming food, in accordance with claim 1, which are characterised in that the notches (7) are in the shape of a series of approximately circular concavities and convexities.

3. Cooking utensils for steaming food, in accordance with claim 1, which are characterised in that the width (24) of the lower part (13) of the main part (1), being the lower part (13) the part of the main part (1) that is situated below the notches (7), is equal to the width (23) of the upper part (14), being the upper part (14) the part of the main part (1) that is situated above the notches (7).

4. Cooking utensils for steaming food, in accordance with claim 1, which are characterised in that the width (24) of the lower part (13) of the main part main part (1), being the lower part (13) the part of the main part (1) situated below the notches (7), is smaller than the width (23) of the upper part (14), being the upper part (14) the part of the main part (1) that is situated above the notches (7).

5. Cooking utensils for steaming food, in accordance with claim 1, which are characterised in that the secondary part (2) is a tray, plate, grid or, in general, any flat part without any depth, provided or not with holes (16) or other means to enable the steam to pass through.

6. Cooking utensils for steaming food, in accordance with claim 1, which are characterised in that the secondary part (2) is a casserole or recipient with a certain depth, provided or not with holes (16) or other means to enable the steam to pass through.

7. Cooking utensils for steaming food, in accordance with claim 6, which are characterised in that the width (18) of the part of the secondary part (2) that remains below the notches (7) in the final positioning of the secondary part (2) in the interior of the main part (1) is smaller than the width (17) of the main part (1) in the area of the notches (7).
